(19) United States
(12) Patent Application Publication
(10) Pub. No.: US 2020/0079277 A1
(43) Pub. Date: Mar. 12, 2020

(54) ASSISTANCE METHOD FOR A LIGHT CONTROL SYSTEM IN A MOTOR VEHICLE, LIGHT CONTROL SYSTEM, COMPUTER PROGRAM PRODUCT, AND COMPUTER-READABLE MEDIUM

(71) Applicant: HELLA GmbH & Co. KGaA, Lippstadt (DE)

(72) Inventors: Ludger WEGHAUS, Lippstadt (DE); Lars-Peter BECKER, Berlin (DE)

(73) Assignee: HELLA GmbH & Co. KGaA, Lippstadt (DE)

(21) Appl. No.: 16/681,432

(22) Filed: Nov. 12, 2019

Related U.S. Application Data
(63) Continuation of application No. PCT/EP2018/061528, filed on May 4, 2018.

(30) Foreign Application Priority Data
May 11, 2017 (DE) 10 2017 110 245.0

(51) Int. Cl. B60Q 1/08; B60Q 1/24

(52) U.S. Cl. CPC B60Q 1/08; B60Q 1/24

(57) ABSTRACT

An assistance method for a light control system in a motor vehicle, having a light controller for controlling a lighting unit in the motor vehicle for lighting a motor vehicle environment, a portable unit, at least one communication interface, and an evaluation unit for evaluating signals from the portable unit received via the communication interface. The lighting unit being controllable by the light controller and based on evaluation of the signals received from the portable unit, such that at least one light beam emitted by the lighting unit can be positioned in accordance with signals from the portable unit. A first assistance function manually or automatically switches on, the lighting unit is controlled such that when the first assistance function is switched on, the light beam moves automatically as a function of the portable unit being actuated at a time that follows the switching on of the first assistance function.

This nonprovisional application is a continuation of International Application No. PCT/EP2018/061528, which was filed on May 4, 2018, and which claims priority to German Patent Application No. 10 2017 110 245.0, which was filed in Germany on May 11, 2017, and which are both herein incorporated by reference.

### BACKGROUND OF THE INVENTION

### Field of the Invention

The present invention relates to an assistance method for a light control system in a motor vehicle, to a light control system for carrying out an assistance method, to a computer program product, and to a computer-readable medium.

### Description of the Background Art

Assistance methods for a light control system in a motor vehicle, light control systems for their implementation, computer program products, and computer-readable media are already known from the prior art in numerous design variants.

For example, a light control system in a motor vehicle is known from DE 10 2012 224 465 A1, which corresponds to U.S. Pat. No. 9,150,143, which includes a light controller for controlling a lighting unit in the motor vehicle for lighting a motor vehicle environment, a portable unit, at least one communication interface, and an evaluation unit for evaluating signals received via the communication interface from the portable unit. When a control button of the portable unit is pressed continuously, the lighting unit is controlled such that a light beam emitted by the lighting unit can be positioned depending on the position of the portable unit.

### SUMMARY OF THE INVENTION

It is therefore an object of the present invention to provide assistance to a user of a portable unit, the assistance being better adapted to the requirements of the individual case, via a light controller for a lighting unit in a motor vehicle.

An advantage of the invention is in particular that, depending on the requirements of the individual case, an advantageous lighting, for example, of a construction site or of a site, otherwise appearing to be of interest, in the motor vehicle environment is made possible. Accordingly, the applicability of the assistance to the user of the portable unit by means of a light controller for a lighting unit in a motor vehicle is not limited to the immediate vicinity of the motor vehicle. The at least one light beam emitted by the lighting unit moves automatically as a function of the portable unit being actuated at a time that follows the switching on of the first assistance function. Because of this flexibility in the orientation of the at least one light beam emitted by the lighting unit, the site to be illuminated by means of the motor vehicle lighting unit, for example, a construction site, can also be illuminated by the motor vehicle lighting unit in the case of motor vehicle front headlights, which are not oriented towards the site to be illuminated, and independent of the position or movement of the portable unit, and thus the position or movement of a user carrying the portable unit. Switching on the first assistance function can also be dependent on additional motor vehicle-related and/or environment-related conditions.

The wording that the light beam emitted by the lighting unit moves or can move automatically as a function of an actuation of the portable unit, as well as the term “light beam” can be understood in general terms here. The term “light beam” likewise comprises light bundles composed of individual light beams and overall light distributions generated by the lighting unit of the motor vehicle.

In principle, the actuation of the portable unit is freely selectable within wide appropriate limits according to its type and mode of operation. For example, it is conceivable that a user actuates the portable unit by means of at least one manual actuation of at least one button of the portable unit. However, an advantageous refinement of the assistance method of the invention provides that the portable unit is actuated by means of a previously specified change in position of the portable unit. As a result, on the one hand, the number of operating elements on the portable unit or at least the functions assigned to them can be reduced. In addition, this enables an intuitive actuation of the portable unit by the user.

The same applies to an advantageous refinement of the light control system of the invention, according to which the portable unit can be actuated by means of a previously specified change in position of the portable unit.

A particularly advantageous refinement of the assistance method of the invention provides that the first assistance function can be switched off manually and/or automatically, wherein the light control system automatically switches on a second assistance function when the first assistance function is switched off. This makes it possible to switch on the second assistance function without further operating steps. Switching on the second assistance function can also be dependent on additional motor vehicle-related and/or environment-related conditions.

The same applies to an advantageous refinement of the light control system of the invention, according to which the first assistance function can be switched off manually and/or automatically, wherein a second assistance function can be switched on automatically when the first assistance function is switched off.

A particularly advantageous refinement of the last-mentioned embodiment of the assistance method of the invention provides that, when the second assistance function is switched on, the light beam emitted by the lighting unit automatically tracks the portable unit in accordance with a motion trajectory of the portable unit. Due to this dynamic in the orientation of the at least one light beam emitted by the lighting unit, the user of the portable unit, for example, the driver of the motor vehicle, is optimally assisted by the lighting unit of the motor vehicle, also during the movement of the portable unit in the motor vehicle environment.

The same applies to an advantageous refinement of the light control system of the invention, according to which the light beam emitted by the lighting unit can automatically track the portable unit in accordance with a motion trajectory of the portable unit when the second assistance function is switched on.

Another particularly advantageous refinement of the assistance method of the invention provides that the light beam emitted by the lighting unit moves when the first assistance function is switched on and/or tracks the portable unit when the second assistance function is switched on such that a carrier of the portable unit is not dazzled. This ensures that the carrier of the portable unit, therefore, the user, is not hindered by the first and/or second assistance function.

In principle, the signal exchange between the portable unit and the at least one communication interface can be freely selected within wide suitable limits according to type and function. Advantageously, the signal exchange between the portable unit and the at least one communication interface takes place automatically. The signal exchange therefore does not need to be initiated or maintained by an operational action of the user. It is particularly advantageous if the signal exchange is designed as a passive signal exchange.

An advantageous refinement of the aforementioned embodiment provides that the signal exchange from the at least one communication interface to the portable unit and/or the signal exchange from the portable unit to the at least one communication interface take place based on a magnetic field technology or based on acoustic signals. Such technologies are often already present in existing systems; for example, magnetic field technology is typically implemented in automotive access systems, and acoustic systems are commonly found in mobile consumer electronic devices such as smartphones or the like.

A further advantageous refinement of the light control system of the invention provides that the portable unit is designed as a UID and the lighting unit as at least one front headlight and/or at least one sidelight and/or at least one backup light of the motor vehicle. In this way, the use of already existing components and assemblies for the light control system of the invention is improved further. The abbreviation “UID” stands for user identification device, therefore, a device by means of which a user authorized to use the motor vehicle can be identified. The portable unit, formed as a UID, thus ensures that the user of the portable unit is authorized, for example, to make adjustments to the motor vehicle.

The assistance method of the invention, the light control system of the invention for carrying out the assistance method, and a corresponding computer program product and a computer-readable medium on which the computer program product is stored are explained in more detail below.

The light control system of the present exemplary embodiment comprises a light controller for controlling a lighting unit of a motor vehicle, designed as a front headlight pair, for lighting a motor vehicle environment, a portable unit designed as a UID, a communication interface, and an evaluation unit for evaluating signals from the UID received via the communication interface. The light controller, the communication interface, and the evaluation unit are integrated into the motor vehicle. The front headlights of the motor vehicle can be controlled by the light controller and in accordance with the evaluation of the signals received from the portable unit, such that a light beam formed as an overall light distribution of the front headlights can be positioned in accordance with the position of the UID. The two front headlights each have a matrix of a plurality of individual light sources with optical attachments, by means of which the overall light distribution of the front headlights can be generated in a manner known to the skilled artisan.

Furthermore, the motor vehicle has an access system by means of which doors of the motor vehicle can be unlocked and locked by means of the UID in a manner known to the skilled artisan. The access system is designed as a so-called passive entry system, in which the user only has to carry the UID with him in order to unlock or lock the motor vehicle doors. Therefore, the user does not need to actively operate the UID to unlock or lock motor vehicle doors. For this purpose, the motor vehicle has, inter alia, a plurality of LF antennas which, when energized cyclically, each generate a magnetic field in the vicinity of the motor vehicle, which can be measured by means of a 3D receiving coil of the UID. As a function of this measurement, the UID generates a signal which can be received via the communication interface of the motor vehicle and forwarded to the evaluation unit.

When the UID is used by a user, for example, the driver of the motor vehicle, it is first automatically checked in a manner known to the skilled artisan whether the UID corresponds to the motor vehicle. Once this has occurred and the UID has been identified as belonging to the motor vehicle, the assistance method of the invention explained below can take place.

If the UID is located in the environment outside the motor vehicle, this will be detected by the light control system. The light control system then automatically switches on a second assistance function. The user therefore does not need to operate a control button of the UID in order to start the second assistance function. When the second assistance function is switched on, both front headlights are switched on and controlled by means of the light controller of the motor vehicle, such that the overall light distribution of the front headlights automatically tracks the UID in accordance with the UID motion trajectory. The tracking of the overall light distribution in the present exemplary embodiment is carried out when the UID and thus the user carrying the UID approach the motor vehicle from the front or diagonally from the front, such that the overall light distribution lights the ground in front of the user.

When the UID and thus the user move forward or diagonally forward from the motor vehicle, the tracking of the overall light distribution is such that the overall light distribution lights the user from behind. Accordingly, in the latter case, the ground is also illuminated in front of the user who is moving away from the motor vehicle. If the UID and thus the user move transversely in front of the motor vehicle, the tracking then takes place such that the overall light distribution lights the ground between the motor vehicle and the user. In all three cases mentioned above, the overall light distribution follows the UID and thus the user constantly; the overall light distribution is tracked continuously. The front headlights are controlled such that the carrier of the UID, therefore, the user of the UID, is not dazzled.

For the above-described tracking of the overall light distribution of the two front headlights, the plurality of LF antennas of the access system of the motor vehicle is energized cyclically, so that the LF antennas each generate a magnetic field in the vicinity of the motor vehicle. These magnetic fields are measured by the 3D receiving coil of the UID. As a function of this measurement, the UID generates a signal which is transmitted by radio to the communication interface of the motor vehicle, received by it, and forwarded to the evaluation unit of the motor vehicle.

Depending on whether the evaluation unit by means of the evaluation detects that the UID and thus the user of the motor vehicle are located in the front region of the motor vehicle, therefore, in the effective range of the two front headlights, the light controller of the light control system controls the two front headlights such that the above-explained overall light distribution of the front headlights results.

However, it is also conceivable to control only individual light sources of the light sources matrix with the optical attachments of both or only one of the two front headlights. If the UID and thus the user are located, for example, diagonally to the left in front of the motor vehicle, it is possible that only at least one light source of the left front headlight is switched on. In an analogous manner, it is possible that only at least one light source of the right front headlight is switched on, if the UID and thus the user are located, for example, diagonally to the right in front of the motor vehicle. If the UID and thus the user are located rather centrally in front of the motor vehicle, in contrast, at least one light source of both front headlights could be switched on. Of course, it is conceivable that instead of switching on one or more light sources of at least one of the two front headlights, other suitable measures known to the skilled artisan are taken to illuminate the environment in the desired manner. By way of example, reference is merely made here to the various possibilities that result from the use of at least one optical attachment in the respective front headlights.

In the present exemplary embodiment, it is provided further that the second assistance function can be switched off manually or automatically, wherein the light control system automatically switches on a first assistance function when the second assistance function is switched off. For example, it is conceivable that the second assistance function is switched off manually by actuating a control button of the UID. The actuation can be designed such that the user of the UID presses the control button three times in quick succession. As soon as the second assistance function has been switched off in this way, the first assistance function is automatically switched on. The user does not need to perform any additional operating step. The first assistance function is designed such that, when the first assistance function is switched on, the overall light distribution of the front headlights can be moved automatically as a function of the portable unit being actuated at a time that follows the switching on of the first assistance function.

However, it is also conceivable that the first assistance function of the light control system can be switched on manually as an alternative or in addition thereto. For example, a manual and/or automatic switching on of the first assistance function of the light control system can also be formed independently of the switch state of a second assistance function. This is provided, for example, in embodiments of the assistance method of the invention and the light control system of the invention which have no second assistance function.

For example, the user of the UID can manually control the overall light distribution of the front headlights by means of the light control system, such that the front headlights serve as a type of construction light for lighting a work area in the front area, therefore, diagonally in front of or centrally in front of the front headlights.

To operate the UID for remote control of the front headlights, it is provided with the first assistance function switched on that the user of the UID can manually direct the overall light distribution of the front headlights by changing the UID position. For this purpose, in the present exemplary embodiment, the user presses the control button of the UID continuously and pivots the UID by hand about one of the three axes of the UID, namely about the longitudinal axis, the transverse axis, or the vertical axis of the UID. The changes in the UID position brought about in this way are detected by means of an acceleration sensor integrated in the UID, evaluated in the UID, transmitted to the communication interface of the motor vehicle in the manner explained above, evaluated in the evaluation unit of the motor vehicle, and used to control the front headlights by means of the light controller.

In order to make it easier for even inexperienced users to carry out the above-described actuation of the UID, it can be provided that appropriate instructions, such as pictograms or the like, are provided on the UID in a manner known to the skilled artisan.

It can also be achieved hereby that the user of the UID also orients it correctly relative to the motor vehicle, thus, for example, by holding it the right way around in the hand.

For example, if the user pivots the UID to the left about the longitudinal axis, the user directs the overall light distribution of the two front headlamps to the left. Pivoting the UID about the longitudinal axis of the UID to the right directs the overall light distribution of the two front headlights to the right. For example, if the user pivots the UID forwards and downwards about the transverse axis, the user directs the overall light distribution of the two front headlamps downwards. Pivoting the UID about the transverse axis of the UID forwards and upwards directs the overall light distribution of the two front headlights upwards. For example, if the user pivots the UID to the left about the vertical axis, then the user focuses the overall light distribution of the two front headlights, whereas pivoting the UID about the vertical axis to the right widens the overall light distribution of the two front headlights. Of course, it is also conceivable that the pivoting of the UID about the respective axes of the UID occurs not successively but simultaneously about at least two of the axes of the UID. As soon as the user has set the overall light distribution as desired in the aforementioned manner, the user again releases the UID control button. The setting process is finished, and the overall light distribution remains as set, therefore, static, regardless of the motion trajectory of the UID and thus the movement of the user of the UID.

As in the case of the second assistance function, glare suppression can also be provided for the user in the case of the first assistance function. For example, by cutting the closer surroundings of the UID and thus the user out of the overall light distribution in a manner known to the skilled artisan, therefore, the position of the UID and thus the user of the UID are not directly illuminated by the front headlights. With this expansion of the first assistance function, a dynamic overall light distribution of the front headlights of the motor vehicle would thus be realized again.

If the user again presses the control button of the UID three times in quick succession, the first assistance function is switched off manually and the second assistance function is switched on automatically at the same time. The rest of the procedure is as already explained above.

In addition, a computer program product can be provided that comprises instructions that cause the light control system to execute the steps of the assistance method.

Furthermore, a computer-readable medium can be provided on which the computer program product is stored.

The invention is not limited to the present exemplary embodiment. For example, the second assistance function can also be switched on manually and/or switched off automatically. In addition, depending on the application, the second assistance function can be designed differently according to type and function. The first assistance function can also be switched on manually and/or switched off automatically. The lighting unit can also be some other exterior lighting of the motor vehicle, such as, for example, sidelights or backup lights. These can also be designed in combination as a lighting unit of the invention.

For example, a lighting unit comprising two front headlights, two sidelights, namely one sidelight on each side of the vehicle, and at least one backup light, would result in the possibility that when the second assistance function is switched on, in accordance with the motion trajectory of the portable unit, the light beam emitted by the lighting unit can automatically track the portable unit in a 360° environment around the motor vehicle. Similarly, it would also be conceivable that when the first assistance function is switched on, as a function of the actuation of the portable unit, the light beam emitted by the lighting unit can be moved automatically around the motor vehicle in a 360° environment. In addition, the lighting unit can also be designed as an auxiliary headlight, which is integrated or mounted, or as some other exterior lighting of the motor vehicle.

The light beam in this case can be designed not only as an overall light distribution of the lighting unit used in each case. For example, it is also conceivable that only individual light sources of the lighting unit, with or without optical attachments, are used and controlled for the first assistance function and/or the second assistance function. Instead of the light sources, it is possible for light sources with at least one optical attachment to control the respective optical attachment.

The portable unit can also be designed in many different ways, depending on the application according to type and function. For example, instead of a portable unit formed as a UID, a portable unit designed as a smartphone or the like could also be used.

Further, it is conceivable that a plurality of portable units are located simultaneously in the motor vehicle environment, for example, when a number of users each with a portable unit move in the motor vehicle environment. The explanations for a single portable unit designed as a UID according to the present exemplary embodiment apply in such a case to each of the plurality of portable units, regardless of whether they are designed as a UID. The plurality of portable units can also be portable units that are different from one another, for example, two UIDs and a smartphone.

In addition to the magnetic field technology used in the exemplary embodiment for the signal exchange between the portable unit and the at least one communication interface of the motor vehicle, other suitable technologies known to the skilled artisan are also conceivable. Examples include the use of acoustic signals, the so-called UWB technology, BTLE technology, or GPS technology. Also, a combination of signal transmission technologies different from one another is possible, for example, when multiple portable units of types that are different from one another or with signal transmission technologies that are different from another are used.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An assistance method for a light control system in a motor vehicle, the light control system comprising a light controller for controlling a lighting unit in the motor vehicle for lighting a motor vehicle environment, a portable unit, at least one communication interface, and an evaluation unit for evaluating signals from the portable unit received via the communication interface, the lighting unit being controllable by the light controller and in accordance with the evaluation of the signals received from the portable unit, such that at least one light beam emitted by the lighting unit is positioned in accordance with signals from the portable unit received via the communication interface, the method comprising:
manually or automatically switching on a first assistance function; and
controlling the lighting unit via the light controller such that when the first assistance function is switched on, the light beam emitted by the lighting unit moves automatically as a function of the portable unit being actuated at a time that follows the switching on of the first assistance function.

2. The assistance method according to claim 1, wherein the portable unit is actuated by a previously specified change in position of the portable unit.

3. The assistance method according to claim 1, wherein the first assistance function is adapted to be switched off manually and/or automatically, and wherein the light control system automatically switches on a second assistance function when the first assistance function is switched off.

4. The assistance method according to claim 3, wherein when the second assistance function is switched on, the light beam emitted by the lighting unit automatically tracks the portable unit in accordance with a motion trajectory of the portable unit.

5. The assistance method according to claim 1, wherein the light beam emitted by the lighting unit moves when the first assistance function is switched on and/or tracks the portable unit when the second assistance function is switched on such that a carrier of the portable unit is not dazzled.

6. The assistance method according to claim 1, wherein the signal exchange between the portable unit and the at least one communication interface takes place automatically.

7. The assistance method according to claim 6, wherein the signal exchange from the at least one communication interface to the portable unit and/or the signal exchange from the portable unit to the at least one communication interface take place based on a magnetic field technology or based on acoustic signals.

8. A light control system for carrying out an assistance method according to claim 1, the system comprising:
a light controller for controlling a lighting unit in a motor vehicle for lighting a motor vehicle environment;
a portable unit;
at least one communication interface; and
an evaluation unit for evaluating signals from the portable unit received via the communication interface,
wherein the lighting unit is controllable by the light controller and in accordance with the evaluation of the signals received from the portable unit, such that at least one light beam emitted by the lighting unit are adapted to be positioned in accordance with signals from the portable unit received via the communication interface, and
wherein a first assistance function of the light control system is adapted to be switched on manually and/or automatically and the light beam emitted by the lighting unit move automatically when the first assistance function is switched on as a function of the portable unit being actuated at a time that follows the switching on of the first assistance function.

9. The light control system according to claim 8, wherein the portable unit is adapted to be actuated via a previously specified change in position of the portable unit.

10. The light control system according to claim 8, wherein the first assistance function is adapted to be switched off manually and/or automatically, and wherein a second assistance function is adapted to be switched on automatically when the first assistance function is switched off.

11. The light control system according to claim 10, wherein the light beam emitted by the lighting unit automatically tracks the portable unit in accordance with a motion trajectory of the portable unit when the second assistance function is switched on.

12. The light control system according to claim 8, wherein the portable unit is a UID and the lighting unit is at least one front headlight and/or at least one sidelight and/or at least one backup light of the motor vehicle.

13. A computer program product comprising instructions for causing a light control system according to carry out the method according to claim 1.

14. A computer-readable medium on which the computer program product according to claim 13 is stored.
